(19) United States
(12) Patent Application Publication
(10) Pub. No.: US 2013/0173404 A1
(43) Pub. Date: Jul. 4, 2013

(54) REAL-TIME USER FEEDBACK

(71) Applicant: German Scipioni, San Jose, CA (US)

(72) Inventor: German Scipioni, San Jose, CA (US)

(21) Appl. No.: 13/714,268

(22) Filed: Dec. 13, 2012

Related U.S. Application Data
(60) Provisional application No. 61/580,992, filed on Dec. 28, 2011.

(51) Int. Cl. G06Q 30/02

(52) U.S. Cl. CPC G06Q 30/0282
USPC 705/16; 705/44

(57) ABSTRACT

A service provider determines a user's location when the user requests to make a payment through the service provider. After the payment processed, the user is provided a feedback form on the user device, such as a smart phone, while the user is still at the payment location. The feedback form may include different ways for the user to quickly and easily provide feedback on the transaction, including speaking into the user device, entering comments, selecting from a list of ratings or satisfaction indicators, etc. The user is then able to provide feedback, which is communicated back to the service provider. The service provider can associate the feedback with the particular transaction and communicate the feedback to the merchant or other parties associated with the transaction, including management, employees, etc.

### CROSS REFERENCE TO RELATED APPLICATION

The present application claims priority to U.S. Provisional Application Ser. No. 61/580,992, filed Dec. 28, 2011, which is incorporated by reference in its entirety.

### BACKGROUND

1. Technical Field

The present application generally relates to user feedback and more particularly to electronic feedback.

2. Related Art

Consumer feedback is important for a merchant to maintain or improve quality. One way for a user or consumer to provide feedback for a service or purchase is through comment cards at the merchant location. For example, a restaurant may provide comment or feedback cards on a consumer's table, at a register, or other location in the restaurant. The cards enable a consumer to comment on the waiter, the food, or anything else the consumer wishes to comment on. While such information may be valuable to the restaurant, consumers may be reluctant to fill out the card or fill it out with much detail because of inconvenience. Furthermore, such cards may not provide the restaurant feedback on a specific transaction or waiter, thereby limiting their potential value.

Other feedback mechanisms include “Like,” thumbs-up, “Dislike,” thumbs-down, or similar buttons or links that the consumer can select. However, these provide very little detail other than whether a consumer likes or dislikes something.

Yet another feedback mechanism is electronic emails sent to the user after the user has purchased an item. The email may contain a link or form that enables the user to provide feedback on the purchase. However, the consumer typically provides the feedback on the actual item and is not done at the time of the purchase, as the consumer typically needs time to use the item before being in a position to provide feedback.

Thus, a need exists for consumers to be able to easily provide meaningful feedback in real-time.

### BRIEF DESCRIPTION OF THE DRAWINGS

FIG. 1 is a flowchart of a process for processing a real-time user feedback according to one embodiment;

FIG. 2 is an illustration of a system used to conduct a real-time user feedback according to one embodiment; and

FIG. 3 is a block diagram of a computer system suitable for implementing one or more components in FIG. 2 according to one embodiment of the present disclosure.

Wherever appropriate, the same reference numbers are used throughout the drawings to refer to the same or like elements.

### DETAILED DESCRIPTION

In one embodiment, a service provider determines a user's location when the user requests to make a payment through the service provider. The payment may be for food, goods, and/or services. After the payment processed, the user is provided a feedback form on the user device, such as a smart phone, while the user is still at the payment location. The feedback form may include different ways for the user to quickly and easily provide feedback on the transaction, including speaking into the user device, entering comments, selecting from a list of ratings or satisfaction indicators, etc. The user is then able to provide feedback, which is communicated back to the service provider. The service provider can associate the feedback with the particular transaction and communicate the feedback to the merchant or other parties associated with the transaction, including management, employees, etc. Thus, the merchant is able to receive immediate feedback on a transaction, associate the feedback with the transaction, and take any actions desired, all in real-time, e.g., when the user is still at the merchant location. Note that transaction can be defined as payment for any item and/or service, including a meal, drinks, physical goods, digital goods, and/or a combination thereof.

In one example, a customer or user goes to a restaurant and orders food. This can be at a counter or at a table. Once ordered, the customer then waits for the food to be prepared and served. After eating the food, the customer is ready to pay for the meal (i.e., the transaction) from a bill presented to the customer. The bill may be a conventional paper bill or a digital bill presented to the user's mobile device, such as a smart phone.

The user makes the payment through the user's mobile device. This can be done in any number of ways through a payment provider, such as PayPal, Inc. of San Jose, Calif. For example, the user may scan a code on the bill or otherwise capture information contained in the bill with the mobile device, such as a merchant identifier, a server (i.e., waiter or waitress) identifier, a transaction ID, an amount of the bill, and/or other details of the purchase, e.g., description of food items and prices. The information is communicated to the payment provider, who retrieves the user's account information with the payment provider and identifies the restaurant (i.e., merchant) or location. The payment provider then processes the payment request from the customer. If the request is approved, a notification may be sent to the customer and/or the merchant (such as through the server), an appropriate amount debited from the user's account, and a corresponding amount credited to an account of the merchant.

With the notification, the payment provider may also communicate a form the customer can use to rate the transaction. The form, generally used herein as any means for the customer to rate the transaction, may be presented in different ways. The form may allow the customer to select from a list of ratings and/or allow personalized comments by text or voice. For example, the customer may be shown, on the customer's mobile device, one or more areas or categories to rate or comment. The areas may include service, food, value, atmosphere, etc. The customer can decide to rate one or more areas by selecting a set list of options, such as one to five stars, thumbs-up or thumbs-down, etc. Alternatively, or in addition to, the customer may enter specific comments for the one or more areas. For example, the customer may use voice to enter the comments or type in the comments through text using a keyboard or keypad. In one embodiment, the customer is given an incentive, such as by the restaurant, to provide comments. Thus, with the notification, the customer may see a message informing the customer that if the customer agrees to submit a comment, the customer is entitled to $10 off the next meal at the restaurant. The customer may also be given an option of requesting a call-back or other follow up (such as an email or text) from the restaurant. This may be beneficial with a very good or very bad review/comment so that the customer can elaborate and/or the restaurant can offer something to make up for a bad service, such as a free meal next time.

Once the customer has provided the desired comments/ratings, the customer can communicate the information to the payment provider, such as by selecting a “send” or other suitable button or link. The payment provider may then process the information and communicate the information to the restaurant and/or other parties, including the server, manager, etc., where the information is tied or associated with the particular meal, such as by a transaction ID, server name, etc. Other parties may include social networks, blogs, restaurant review sites, etc. Processing may also include placing the earned incentive into the customer's account, notifying the restaurant to provide the incentive to the customer, which can be done immediately at the restaurant, sending the incentive by email or text to the user, etc.

The restaurant may use the information to send a message to the server, manager, or others, such as congratulating them on a positive feedback or informing them of an area they need to improve. The feedback from multiple customers can be compiled, either by the payment provider or the restaurant, to help the restaurant be more successful and profitable.

Continuing with a more specific restaurant use case, the following illustrates various advantages of aspects of the present idea. Joe's taco shop now accepts PayPal as a payment option. Billy has a great waiter, and after he pays his bill using PayPal on Billy's mobile phone, Billy sees a form that says “Rate your waiter and enter to win a free lunch.” Billy agrees and gives his waiter 5 out of 5 fish tacos on the provided feedback scale. At the end of the day, the waiter gets a text from Joe saying “Congrats, your average score was 4.9 today so your tips went from $35 yesterday to $43 today for the great work today!” The waiter then goes home and buys an ice cream with his PayPal debit card. The waiter's tips may have been deposited directly into Billy's PayPal account by Joe's taco shop or by Billy through Billy's account with PayPal. Joe, the owner, logs into his dashboard to see how he did in sales that day and how his waiters did as well.

Note that the real-time rating after purchase can be used for other types of transactions, not just meals.

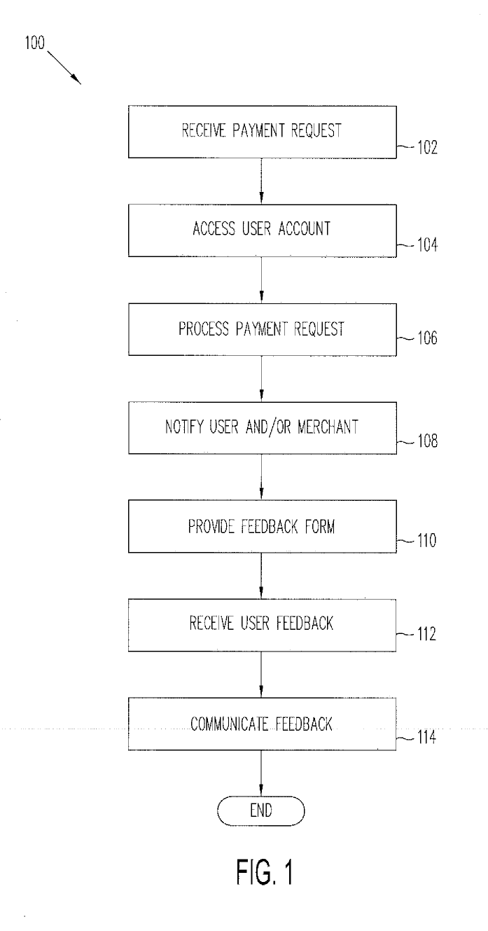

FIG. 1 is a flowchart of a process 100 for processing a real-time user feedback according to one embodiment. At step 102, a service or payment provider, such as PayPal, receives a payment request from a user or customer. The user may have an account with the payment provider that enables the user to make payments to others through the payment provider. The payment request may be for a purchase of items, services, physical goods, digital goods, a donation, etc. at a location, such as a physical store, a temporary merchant location, such as from a food truck or swap meet merchant, and the like. The payment request may be received from a user device or from a merchant device, such as a smart phone, computing tablet, or other computing device. In the former, the user may scan a bill/invoice, enter appropriate information, such as a merchant or payee identifier and an amount, or convey the request in any suitable matter. In the latter, the merchant may scan or otherwise capture information from the user device or user payment instrument and send that information, along with transaction information, to the service provider to request payment. Transaction information can include a merchant identifier, an amount, description of items purchased, etc.

After receiving the payment request, the service provider may access the user's account, at step 104. The payment request may include a user or device identifier that enables the service provider to locate a user account with the payment provider. For example, the payment request may include a user name, email address, and/or phone number. This information, along with a password or PIN, may have been communicated to the service provider before, during, or after the payment request, such as when the user accesses or logs into the user account by entering requested information into the user device. For example, the user may open an app provided by the service provider or enter a website address of the service provider and then enter at least a password or PIN.

The service provider may then process the payment request at step 106. Processing may include, in one or more steps, determining a location of the user, merchant, and/or PUS, determining whether there are restrictions or limitations on the user's account that are applicable to the payment request, and/or any other security/fraud analysis. Location may be determined from a GPS or other location mechanism in the user's device, information contained in the payment request, such as the merchant address, an identifier that associates to an address, a location mechanism in a merchant device at the POS, etc. For example, the location may be a merchant store or other “brick-and-mortar” location. The location may also be a temporary location, such as a swap meet stand, a food truck, or the like.

After the payment request is processed and approved, the user and/or the merchant may be notified at step 108. Notification may be a confirmation sent by the service provider to the user device and/or a merchant device, such as a POS terminal or checkout tablet/mobile device.

Along with the notification (or before or after), the user is also provided with a feedback form at step 110. The feedback form may be provided in various formats on the user device. For example, the form may have a field or box where the user can enter comments, such as through text or voice. The form may also or alternatively have one or more categories for the user to provide a rating or comment. The categories may be generic, specific to the type of merchant or purchase, or specific to the particular merchant. For example, each merchant may provide to the service provider a specific set of areas for rating or comment, which the service provider then provides to the user. In addition to free-form entry of comments through text and/or voice, the user may also or alternatively provide feedback through drop down menus of ratings/comments to choose from, select one of a plurality of ratings or satisfaction indicators, etc.

Some non-limiting examples include ratings or feedback of the service, the food, the item, the price, the value, the cleanliness, the convenience, the overall experience, the ambiance, the quality, etc. As noted above, the ratings may vary based on the type of transaction/merchant, the specific merchant, location, or be the same for all transactions. A merchant may have preselected feedback options for the user to select from, which makes it easier and possibly more likely that the user will provide feedback. However, preselected feedback options may not be as useful as free-form comments because they make lack the detail possible for free-form comments. A free-form box or field may be provided along with preselected feedback options if desired.

Another way to make it more likely that a user will actually provide feedback is to offer the user an incentive. For example, the feedback form may include an incentive of a certain percentage discount, free item, dollar discount, discounted item(s), etc. on a subsequent visit for submitting a feedback. Conditions may apply, such as the incentive is given only if the complete form is filled out and submitted, although in other embodiments, that may not be required.

The user may also be given an option of requesting a call-back or other follow up (such as an email or text) from the merchant. This may be beneficial with a very good or very bad review/comment so that the user can elaborate and/or the merchant can offer something to make up for a bad service or meal. This may also be beneficial to incentivize the user to submit feedback, since the user may be provided a quick response to the feedback.

At step 112, the service provider receives user feedback from the feedback form. Once the user has provided the desired feedback, the user can transmit the information to the service provider via the user device, such as by selecting a “Send” or other suitable button or link. In addition to user feedback, the feedback form or the transmission of the feedback form may contain one or more identifiers that allow the service provider to associate the particular feedback with the user, merchant, and transaction. The merchant or transaction information may include the name of the clerk, manager, or server responsible for the transaction, time and date of the transaction, what was purchased in the transaction, etc.

The service provider may then process the information and communicate the information, at step 114, to the merchant and/or other parties, including the server, manager, etc. The information may be communicated to a device of the individual or the merchant and can be in real-time (e.g., as soon as or immediately after the feedback is received and processed by the service provider) or at a later time, such as at the end of a worker's shift, store hours, etc. In that case, the service provider may compile all feedback received during this time and provide unfiltered user feedback and/or a summary of the feedback.

Information may be tied to or associated with the particular transaction, such as by a transaction ID, employee name, employee number, etc. This allows the service provider to direct or route the information to the desired individual(s). In other embodiments, the feedback information may be communicated to non-individuals, such as social networks, blogs, review sites, etc. Who the feedback information is communicated to may depend on user permissions, merchant permissions, and/or other factors.

In addition to providing feedback information to interested parties, the service provider may also process any additional items associated with the real-time user feedback process. For example, the service provider may credit a user account with funds, a coupon, or other incentive earned by completing the feedback form. Other examples include notifying the merchant that the user has successfully completed the feedback form and to provide the appropriate incentive to the user, which can be done immediately at the merchant location, sending the incentive by email or text to the user, etc.

Note that one or more steps described herein may be omitted, combined, and/or performed in a different sequence in different embodiments.

Because the customer is able to provide comments/feedback easily through the customer's mobile device and because the comments are tied to the particular transaction/payment, the restaurant may be able to receive comments from more customers that are more useful than previous customer comments that do not identify a particular transaction. The merchant may use this real-time feedback information in numerous ways, such as sending a message to the server, manager, or others to congratulate them on a positive feedback or informing them of an area they need to improve. The feedback from multiple users can be compiled, either by the service provider or the merchant, to help the merchant be more successful and profitable. Issues may be handled while the user is still at the merchant, which may help to retain the user as a customer than losing the user as an unhappy customer.

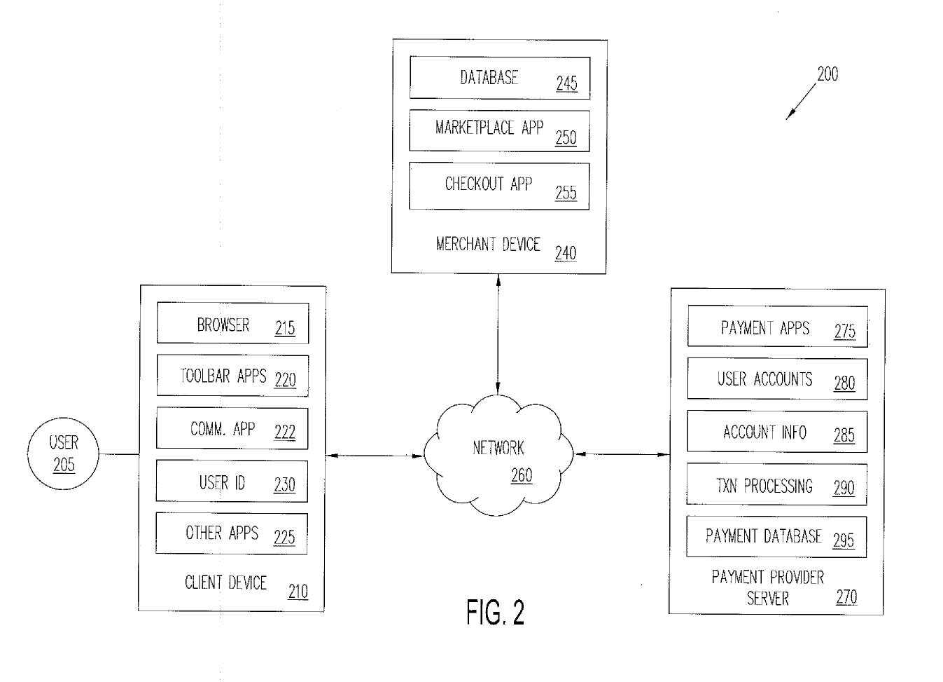

FIG. 2 is a block diagram of a networked system 200 configured to handle a user feedback process through a user device, such as described above, in accordance with an embodiment of the invention. System 200 includes a user device 210, a merchant server 240, and a payment provider server 270 in communication over a network 260. Payment provider server 270 may be maintained by a payment provider, such as PayPal, Inc. of San Jose, Calif. A user 205, such as a consumer, utilizes user device 210 to make a purchase transaction facilitated by payment provider server 270, with one or more merchants, and provide feedback on the transaction. Feedback may be routed to one or more devices associated with merchant server 240, such as employee mobile phones, merchant computing tablets, and the like.

User device 210, merchant server 240, and payment provider server 270 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 260.

Network 260 may be implemented as a single network or a combination of multiple networks. For example, in various embodiments, network 260 may include the Internet or one or more intranets, landline networks, wireless networks, and/or other appropriate types of networks.

User device 210 may be implemented using any appropriate hardware and software configured for wired and/or wireless communication over network 260. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 210 may include one or more browser applications 215 which may be used, for example, to provide a convenient interface to permit user 205 to browse information available over network 260. For example, in one embodiment, browser application 215 may be implemented as a web browser configured to view information available over the Internet or access a website of the payment provider. User device 210 may also include one or more toolbar applications 220 which may be used, for example, to provide client-side processing for performing desired tasks in response to operations selected by user 205. In one embodiment, toolbar application 220 may display a user interface in connection with browser application 215.

User device 210 may further include other applications 225 as may be desired in particular embodiments to provide desired features to user device 210. For example, other applications 225 may include security applications for implementing client-side security features, programmatic client applications for interfacing with appropriate application programming interfaces (APIs) over network 260, or other types of applications. Applications 225 may also include email, texting, voice and IM applications that allow user 205 to send and receive emails, calls, texts, and other notifications through network 360, as well as applications that enable the user to create, send, and receive feedback through the payment provider as discussed herein. User device 210 includes one or more user identifiers 230 which may be implemented, for example, as operating system registry entries, cookies associated with browser application 215, identifiers associated with hardware of user device 210, or other appropriate identifiers, such as used for payment/user/device authentication or identification. In one embodiment, user identifier 230 may be used by a payment service provider to associate user 205 with a particular account maintained by the payment provider. A communications application 222, with associated interfaces, enables user device 210 to communicate within system 200.

Merchant server 240 may be maintained, for example, by a merchant or seller offering various items, products and/or services at a merchant location. Generally, merchant server 240 may be maintained by anyone or any entity that receives money, which includes charities as well as retailers and restaurants. Merchant server 240 includes a database 245 identifying available products and/or services (e.g., collectively referred to as items) which may be made available for viewing and purchase by user 205. Merchant server 240 also includes a marketplace application 250 which may be configured to serve information over network 260 to browser 215 of user device 210 and/or payment provider server 270. In one embodiment, user 205 may interact with marketplace application 250 to view various items available for purchase from the merchant, as well as see invoices from the merchant for payment.

Merchant server 240 also includes a checkout application 255 which may be configured to facilitate the purchase by user 205 of goods or services identified by marketplace application 250. Checkout application 255 may be configured to accept payment information from or on behalf of user 205 through payment service provider server 270 over network 260. For example, checkout application 255 may receive and process a payment confirmation from payment service provider server 270, as well as transmit transaction information to the payment provider and receive information from the payment provider (e.g., a transaction ID). Checkout application 255 may also be configured to communicate feedback forms and feedback information as discussed herein.

Note that merchant server 240 may be in communication with one or more devices (not shown) associated with the merchant. These devices may belong to a merchant employee, such as a waiter, clerk, manager, etc., a social network, blog site, review site, etc., a parent company of the merchant, and/or any other entity or person who may have interest in feedback provided by a user.

Payment provider server 270 may be maintained, for example, by an online payment service provider which may provide payment between user 205 and the operator of merchant server 240. In this regard, payment provider server 270 includes one or more payment applications 275 which may be configured to interact with user device 210 and merchant server 240 over network 260 to facilitate the purchase of goods or services by user 205 of user device 210 and a real-time feedback process as described herein.

Payment provider server 270 also maintains a plurality of user accounts 280, each of which may include account information 285 associated with individual users. For example, account information 285 may include private financial information of users of devices such as account numbers, passwords, device identifiers, user names, phone numbers, credit card information, bank information, or other financial information which may be used to facilitate online transactions by user 205. Account information 285 may also include information associated with a feedback process described herein. Advantageously, payment application 275 may be configured to interact with merchant server 240 on behalf of user 205 during a transaction with checkout application 255 to handle payments and feedback.

A transaction processing application 290, which may be part of payment application 275 or separate, may be configured to receive information from a user device and/or merchant server 240 for processing and storage in a payment database 295. Transaction processing application 290 may include one or more applications to process info nation from user 205 and/or the merchant for processing a transaction from user device 210 as described herein. As such, transaction processing application 290 may store details a transaction and associate the details accordingly for individual users, including feedback from the user for specific merchants and/or transactions. Payment application 275 may be further configured to determine the existence of and to manage accounts for user 205.

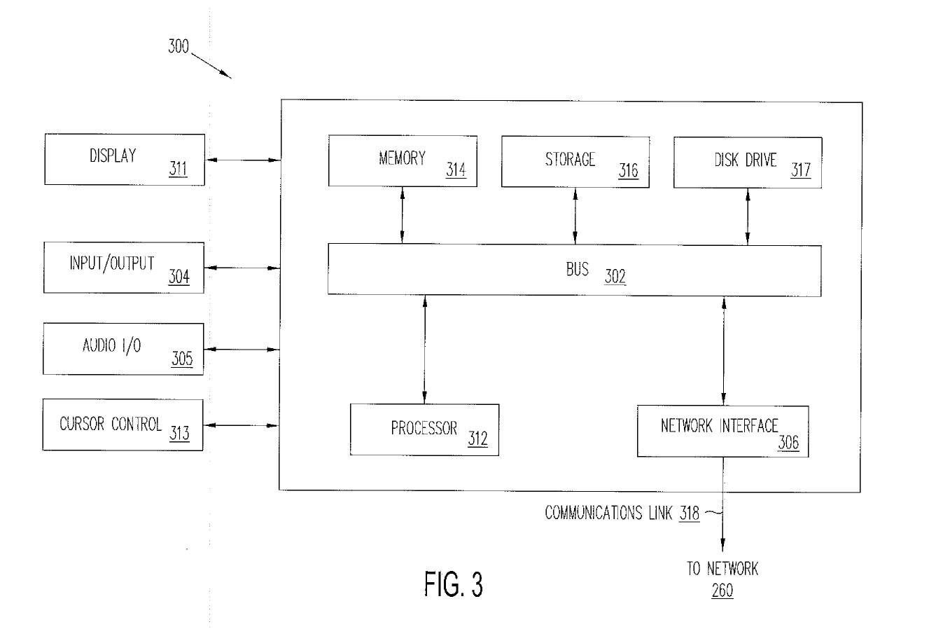

FIG. 3 is a block diagram of a computer system 300 suitable for implementing one or more embodiments of the present disclosure. In various implementations, the user device may comprise a personal computing device (e.g., a personal computer, laptop, smart phone, tablet, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 300 in a manner as follows.

Computer system 300 includes a bus 302 or other communication mechanism for communicating information data, signals, and information between various components of computer system 300. Components include an input/output (I/O) component 304 that processes a user action, such as selecting keys from a keypad/keyboard, selecting one or more buttons or links, etc., and sends a corresponding signal to bus 302. I/O component 304 may also include an output component, such as a display 311 and a cursor control 313 (such as a keyboard, keypad, mouse, etc.). One or more optional audio/video (A/V) input/output (I/O) components 305 may also be included to allow a user to use voice and/or video for inputting information by converting audio signals. A/V I/O component 305 may allow the user to hear audio. A transceiver or network interface 306 transmits and receives signals between computer system 300 and other devices, such as another user device, a merchant server, or a payment provider server via network 360. In one embodiment, the transmission is wireless, although other transmission mediums and methods may also be suitable. A processor 312, which can be a micro-controller, digital signal processor (DSP), or other processing component, processes these various signals, such as for display on computer system 300 or transmission to other devices via a communication link 418. Processor 312 may also control transmission of information, such as cookies or IP addresses, to other devices.

Components of computer system 300 also include a system memory component 314 (e.g., RAM), a static storage component 316 (e.g., ROM), and/or a disk drive 317 to store information, such as account information, transaction numbers, machine IDs, and other information described above. Computer system 300 performs specific operations by processor 312 and other components by executing one or more sequences of instructions contained in system memory component 314. Instructions may be performed by one or more processors 312. Logic may be encoded in a computer readable medium, which may refer to any medium that participates in providing instructions to processor 312 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 318 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more machine readable mediums, including non-transitory machine readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Embodiments described herein are exemplary only. One skilled in the art may recognize various alternative embodiments from those specifically disclosed. Those alternative embodiments are also intended to be within the scope of this disclosure. As such, the embodiments are limited only by the following claims.

I claim:

1. A system comprising:
a non-transitory memory storing user account information, wherein the information comprises a user account identifier and transaction information with at least one merchant; and
one or more hardware processors for
receiving a payment request for a transaction with a merchant from a user via a mobile device at a point of sale;
processing the payment request;
notifying the user if the payment request is approved, wherein the notifying comprises including a form on the mobile device to rate the transaction;
receiving feedback from the form through the mobile device;
associating the feedback with the transaction; and
communicating the feedback to the merchant.

2. The system of claim 1, wherein the merchant is a restaurant.

3. The system of claim 1, wherein the form comprises a rating for a person associated with the transaction.

4. The system of claim 1, wherein the form includes rating options for the user to select.

5. The system of claim 1, wherein the form comprises a field where the user can enter a comment by voice or text.

6. The system of claim 1, wherein the form displays an incentive to the user for completing, partially or completely, the form.

7. The system of claim 1, wherein the communicating is at the point of sale.

8. The system of claim 1, wherein the feedback is compiled and communicated with other feedback at a time after the transaction.

9. The system of claim 1, wherein the communicating is to a plurality of parties or entities.

10. The system of claim 1, wherein the communicating is to at least one of a person associated with the merchant, a person associated with the transaction, a review site, a blog site, a manager, and a parent company.

11. A non-transitory machine-readable medium comprising a plurality of machine-readable instructions which when executed by one or more processors of a server are adapted to cause the server to perform a method comprising:
receiving a payment request for a transaction with a merchant from a user via a mobile device at a point of sale;
processing the payment request;
notifying the user if the payment request is approved, wherein the notifying comprises including a form on the mobile device to rate the transaction;
receiving feedback from the form through the mobile device;
associating the feedback with the transaction; and
communicating the feedback to the merchant.

12. The non-transitory machine-readable medium of claim 11, wherein the form comprises a rating for a person associated with the transaction.

13. The non-transitory machine-readable medium of claim 11, wherein the form includes rating options for the user to select.

14. The non-transitory machine-readable medium of claim 11, wherein the form comprises a field where the user can enter a comment by voice or text.

15. The non-transitory machine-readable medium of claim 11, wherein the communicating is at the point of sale.

16. The non-transitory machine-readable medium of claim 11, wherein the feedback is compiled and communicated with other feedback at a time after the transaction.

17. A method comprising:
receiving, by a hardware processor of a service provider, a payment request for a transaction with a merchant from a user via a mobile device at a point of sale;
processing the payment request;
notifying the user, electronically by the processor, if the payment request is approved, wherein the notifying comprises including a form on the mobile device to rate the transaction;
receiving feedback from the form through the mobile device;
associating the feedback with the transaction; and
communicating, electronically by the processor, the feedback to the merchant.

18. The method of claim 17, wherein the form comprises a rating for a person associated with the transaction.

19. The method of claim 17, wherein the form includes rating options for the user to select.

20. The method of claim 17, wherein the form comprises a field where the user can enter a comment by voice or text.

21. The method of claim 17, wherein the communicating is at the point of sale.
